(19) United States
(12) Patent Application Publication
(10) Pub. No.: US 2025/0287905 A1
(43) Pub. Date: Sep. 18, 2025

(54) Portable Stabling Apparatus

(71) Applicant: Ryan Roush, Vermontville, MI (US)

(72) Inventor: Ryan Roush, Vermontville, MI (US)

(21) Appl. No.: 18/605,232

(22) Filed: Mar. 14, 2024

(51) Int. Cl. A01K 1/00

(52) U.S. Cl. CPC A01K 1/0035; A01K 1/0094

(57) ABSTRACT

An improved portable stabling apparatus providing two (2) lightweight panel types, a first panel (or front panel), and a second panel (or side panel or back panel) with an inclusive coupling system that uses or only needs fixed pins and two (2) separate collars (e.g., a slide collar providing a combination of a main tube, a primary pocket, and a secondary pocket and a free collar) to install, assemble, and create stables or stall in various configurations and ways on various terrain. Additionally, the first panel (or front panel) incorporates unique locking mechanisms and slide hinges for attaching and use of gates within the first panel (or front panel). Option to remove top portion of canvas from second panel is also provided.

### I. CROSS-REFERENCE TO RELATED APPLICATION

Not applicable.

### II. FIELD OF THE INVENTION

The present invention relates to a portable stabling apparatus and, more particularly, to a new and improved portable stabling apparatus such as for equestrian and agricultural uses.

### III. DESCRIPTION OF THE PRIOR ART

Portable stabling devices have been known in the art for a very long time. In all of that time, the currently available portable stabling devices that provide and require, for example, at least three (3) different panels, separate connecting pins, and/or sliding collar with fixed pins that have very tight tolerances with minimal play. As a results, these devices with all of the different panels and various parts and minimal flexibility in the coupling system make them much more difficult and time consuming to assemble; are additionally very heavy likewise increasing difficulty and time consumption to assemble; further include with the designs very specific storage requirements; and are also typically designed for the general public instead of providing a stall design that is focused on rental specific uses such as for equestrian and agricultural uses that require the portable stabling design to be, among other desires, extremely efficient, safe, lightweight, durable, and versatile.

Accordingly, Applicant's new and improved inventive portable stabling apparatus, as described herein, has solved these problems and further maximize efficiency by simplifying the set up and tear down process-while also adding safety and longevity to the design. Thus, there is a need and there has never been disclosed Applicant's unique portable stabling apparatus.

### IV. SUMMARY OF THE INVENTION

The present invention is an improved portable stabling apparatus providing two (2) lightweight panel types, a first panel (or front panel), and a second panel (or side panel or back panel) with an inclusive coupling system that uses or only needs fixed pins and two (2) separate collars (e.g., a slide collar providing a combination of a main tube, a primary pocket, and a secondary pocket and a free collar) to install, assemble, and create stables or stall in various configurations and ways on various terrain. Additionally, the first panel (or front panel) incorporates unique locking mechanisms and slide hinges for attaching and use of gates within the first panel (or front panel).

### V. BRIEF DESCRIPTION OF THE DRAWINGS

The Description of the Preferred Embodiment will be better understood with reference to the following figures:

FIG. 1 is a front perspective view of Applicant's portable stabling device and, in particular, illustrating the front panel (including the gate or door) and side panel.

FIG. 2 is a front view of Applicant's portable stabling device and, in particular, illustrating the front panel (including the gate or door).

FIG. 3 is a front view of Applicant's portable stabling device and, in particular, illustrating one side of the side panel and/or back panel.

FIG. 4 is a front view of Applicant's portable stabling device and, in particular, illustrating the other or opposite side of the side panel and/or back panel from that illustrated in FIG. 3.

FIG. 5 is a front perspective view of Applicant's portable stabling device and, in particular, illustrating the slide collar in slideable communication with a vertical bar of the frame; and a tool used in connection with releasing or moving the slide collar in relation to the vertical bar of the frame.

FIG. 6A is an exploded view taken from FIG. 1 of Applicant's portable stabling device and, in particular, illustrating the slide collar in slideable communication with a vertical bar of the frame from a first side panel or back panel and moveable for engagement with, or attachment to, a pin on a vertical bar of the frame of a second side panel.

FIG. 6B is an exploded view taken from FIG. 1 of Applicant's portable stabling device and, in particular, illustrating the slide collar in slideable communication with a vertical bar of the frame from a first side panel or back panel and in engagement with, or attached to, a pin on the vertical bar of the frame of a second side panel.

FIG. 7 is a side perspective view of Applicant's portable stabling device and, in particular, illustrating the slide collar with a vertical bar of the frame of a first side panel or back panel and in engagement with, or attached to, a pin on the vertical bar of the frame of a second side panel.

FIG. 8 is a side perspective view of Applicant's portable stabling device and, in particular, illustrating the slide collar with a vertical bar of the frame of a second back panel and in engagement with, or attached to, a first pin on the vertical bar of the frame of a first side panel and a second pin on the vertical bar of the frame of a first back panel.

FIG. 9 is a side perspective view of Applicant's portable stabling device and, in particular, illustrating the slide collar with a vertical bar of the frame of a first back panel and in engagement with, or attached to, a first pin on the vertical bar of the frame of a first side panel and a second pin on the vertical bar of the frame of a second side panel with the first pin and the second pin both being received into and sharing the primary pocket of the slide collar.

FIG. 10 is a side perspective view of Applicant's portable stabling device and, in particular, illustrating the slide collar with a vertical bar of the frame of a second back panel and in engagement with, or attached to, a first pin on the vertical bar of the frame of a first side panel and a second pin on the vertical bar of the frame of a second side panel and a third pin on the vertical bar of the frame of the first back panel with the first pin and the second pin both being received into and sharing the primary pocket of the slide collar and the third pin being received into the secondary pocket of the slide collar.

FIG. 11 is a side perspective view of Applicant's portable stabling device and, in particular, illustrating the front panel and the side panel and back panel forming a double stable in a single row with the first stable shown as formed and the second stable being formed.

FIG. 12 is an exploded view from FIG. 1 of Applicant's portable stabling device and, in particular, illustrating the free collar in engagement with, or attached to, a first pin on the vertical bar of the frame of a side panel and a second pin on the vertical bar of the frame of a back panel.

FIG. 13 is an exploded view taken from FIG. 11 a front perspective view of Applicant's portable stabling device and, in particular, illustrating the free collar being used to support and level the frame of a front panel, side panel, or back panel when placed on uneven ground to align the pins to allow slide collar engagement.

FIG. 14A is an exploded view taken from FIG. 2 of Applicant's portable stabling device and, in particular, illustrating the slide hinge in slideable communication with a vertical hinge bar for the gate (as shown being moveable in the direction of the down arrow) for use in connection with the gate or door of the front panel.

FIG. 14B is an exploded view taken from FIG. 2 of Applicant's portable stabling device and, in particular, illustrating the slide hinge in slideable communication with a vertical hinge bar for the gate (as shown being moveable in the direction of the up arrow) for use in connection with the gate or door of the front panel; and this also adds further safety as it is then more difficult for animal legs to get trapped.

FIG. 14C is a cross-sectional view taken from FIG. 14B of Applicant's portable stabling device and, in particular, illustrating the slide hinge in slideable communication with a vertical bar of the frame from the gate for use in connection with the door of the gate.

FIG. 15 is a front perspective view of Applicant's portable stabling device and, in particular, illustrating the locking mechanism for the gate or door on the front panel.

### VI. DETAILED DESCRIPTION OF THE PREFERRED EMBODIMENT

While this invention is susceptible of embodiment in many different forms, there is shown in the drawings and described herein in detail specific embodiments with the understanding that the present disclosure is to be considered as an exemplification of the principles of the invention and is not intended to limit the invention to the embodiments illustrated.

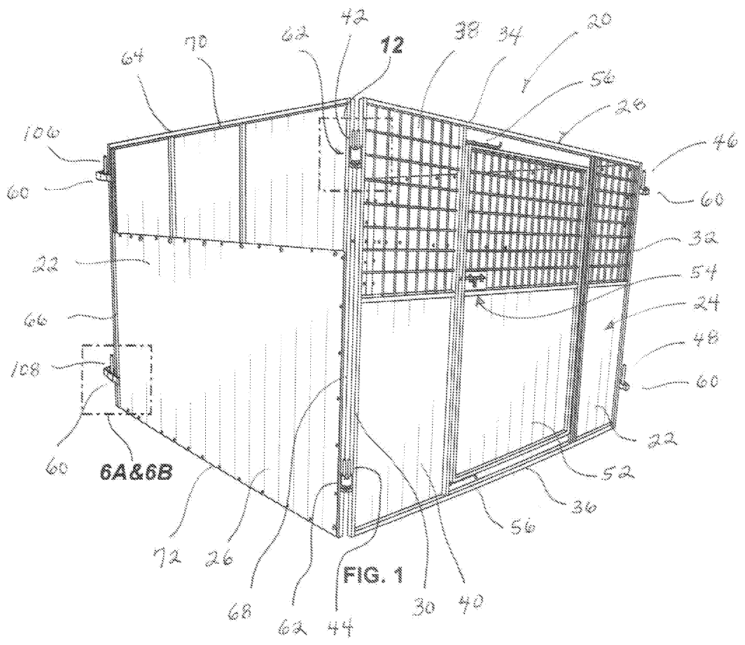

It will be understood that like or analogous elements and/or components, referred to herein, may be identified throughout the drawings with like reference characters. It will be further understood that FIGS. 1-19 are merely schematic representations of the device and some of the components may have been distorted from their actual scale for pictorial clarity.

In accordance with the present invention, and beginning with FIG. 1, there is illustrated Applicant's portable stabling apparatus 20 (also, referred to as stable 20, stall 20, or device 20). At the outset, Applicant's design is preferably a powder coated, sealed, steel frame construction that provides flexibility and safety while also providing storage versatility. The sealed (especially in the corners), steel frame construction prevents moisture from entering the steel frame and prevents rust or rot forming internally. Applicant's design (as discussed in detail below) also requires or uses only two (2) lightweight panel types with an inclusive coupling system that uses only two (2) separate collars. The stable 20 is preferably covered with a canvas 22, that is preferably a 40-ounce canvas with a 1-inch-wide stitched reinforced border which saves weight and absorbs any hard kicks such as, for example, from horses in an equestrian use to increase the panel life of the stable 20 while reducing chance of injury such as to the horses. Alternatively, the stable 20 may be covered with vinyl or any other material desired.

The stable 20 provides a first panel 24 (also, referred to as a front panel 24) and a second panel 26 (also, referred to as a side panel 26 or back panel 26). In one embodiment, as illustrated in FIG. 1, the stable 20 is formed together using one (1) first panel 24 and three (3) second panel 26 (e.g., which consists of two (2) side panels 26 and one (1) back panel 26).

The first panel 24 or front panel 24 provides a four-sided, first panel frame 28 or front panel frame 28 and is assembled together using vertical bars 30, 32 and horizontal bars 34, 36. Preferably, to reduce weight, the vertical bars 30, 32 and the horizontal bars 34, 36 are hollow tubes.

In the preferred embodiment, the front panel 24 is separated into two sections: a top section 38 and a bottom section 40. The top section 38 is preferably a mesh screen made of steel or, alternatively, a thin textile material providing many small holes (e.g., such as square as illustrated or in any other shape as desired). In this manner, such as for equestrian use, the horse being stabled or rider, trainer, or other person using the stable 20 can see through the front panel 24. The bottom section 40 is preferably covered with the canvas 22.

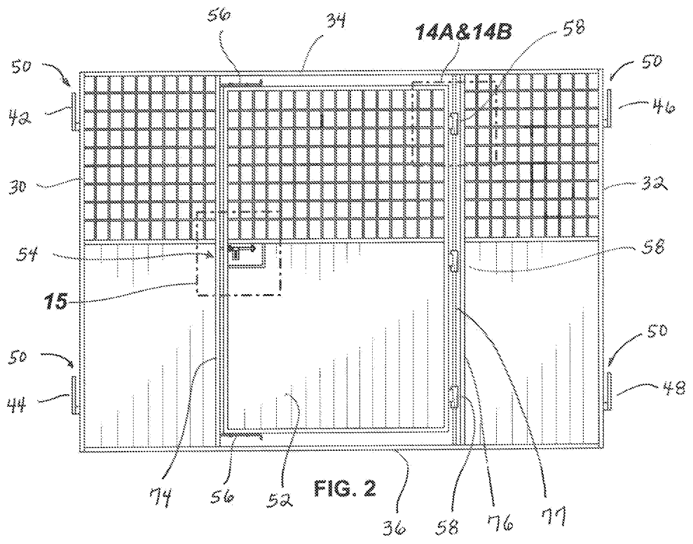

First panel or front panel pins 42, 44, 46, and 48, and as further illustrated in FIG. 2, are fixedly secured or attached to the vertical bars 30, 32. In the preferred embodiment, first panel or front panel pins 42 and 44 are fixedly secured or attached to the vertical bar 30, with first panel or front panel pin 42 situated adjacent to the top section 38 and first panel or front panel pin 44 situated adjacent to the bottom section 40; and first panel or front panel pins 46 and 48 fixedly secured or attached to the vertical bar 32, with first panel or front panel pin 46 situated adjacent to the top section 38 and first panel or front panel pin 44 situated adjacent to the bottom section 40. Each of the first panel or front panel pins 42, 44, 46, and 48 are long and narrow and identical to one another and provide a gap or separation 50 (see FIG. 2) between each of the first panel or front panel pins 42, 44, 46, and 48 and the vertical bars 30, 32 to receive a slide collar 60, of an adjacent panel, or free collar 62, as described in more detail below.

Situated in the center of the front panel 24 is a gate or door 52 to allow for access into and out of the stable 20 through the front panel 24. In the preferred embodiment and as discussed in more detail below, a first locking mechanism 54, a second locking mechanism 56, and slide hinges 58 (see FIG. 2) are provided.

Also illustrated in FIG. 1, the second panel 26 (also referred to as side panel 26 or back panel 26, as this different nomenclature is used when describing the assembly of the panels to form the stable 20) provides a four-sided, second panel frame 64 (also, referred to as side panel frame 64 or back panel frame 64) and is assembled together using vertical bars 66, 68 and horizontal bars 70, 72. Preferably, to reduce weight, the vertical bars 66, 68 and the horizontal bars 70, 72 are hollow tubes. In the preferred embodiment, the vertical bars 66, 68 and horizontal bars 70, 72 of the second panel 26 are substantially identical to the vertical bars 30, 32 and the horizontal bars 34, 36 of the first panel 24.

Turning to FIGS. 2 and 15, the first panel 24 or front panel 24 and the first locking mechanism 54 are more clearly illustrated. Supporting vertical bars 74, 76 are used to frame in and secure the gate or door 52 within the first panel 24 or front panel 24. The first locking mechanism 54 is situated in the middle of the gate or door 52 and is in releaseable communication with the supporting vertical bar 74. The first locking mechanism 54 provides a recess 78. Situated within the recess 78 is a latch rod retainer 80 that is fixedly secured to the gate or door 52 and provides a hollow receiving hole 82. A lock pin 84 is in slideable engagement with the latch rod retainer 80 such that the lock pin 84 is retained and freely moveable within the hollow receiving hole 82 of the latch rod retainer 80. The gate or door 52 is provided with a pass-through hole 90 and the supporting vertical bar 74 is provided with a latch pocket 92.

In this manner, while still being retained by the latch rod retainer 80, the lock pin 84 is moveable within the hollow receiving hole 82 of the latch rod retainer 80 such that the lock pin 84 can extend through the pass-through hole 90 of the gate or door 52 and into the latch pocket 92 of the supporting vertical bar 74. Preferably, the latch pocket 92 is elongated and has a height 94 to allow plenty of space (vertically) to receive the lock pin 84 to accommodate a tolerance in the height or alignment of the gate or door 52 to the supporting vertical bar 74. A clasp 86, which is fixedly secured to and extends outwardly from the lock pin 84, uses a clasp retainer 88 to then releaseably attach the lock pin 84 to the gate or door 52 and thereby secure the gate or door 52 to the first panel 24 or front panel 24 when the gate or door 52 is to be in the closed position.

When the clasp 86 is rotated from attachment to the clasp retainer 88 on the gate or door 52, the lock pin 84, while still being retained within or by the latch rod retainer 80 and, the gate or door 52, is moveable in the opposite direction within the pass-through hole 90 of the gate or door 52 and the hollow receiving hole 82 of the latch rod retainer 80 such that the lock pin 84 is removed from the latch pocket 92. When this occurs, the gate or door 52 is released from the first panel 24 or front panel 24 and placed in the open position.

The second locking mechanism 56, situated at both the top and bottom of the gate or door 52, are additional means for securing the gate or door 52 to the first panel 24 or front panel 24. The second locking mechanism 56 is preferably the same as the first locking mechanism 54 except without the need or use of the clasp 86, the clasp retainer 88, and/or the pass-through hole 90 of the gate or door 52. Alternatively, the first locking mechanism 54 and the second locking mechanism 56 may be any locking means known to one skilled in the art.

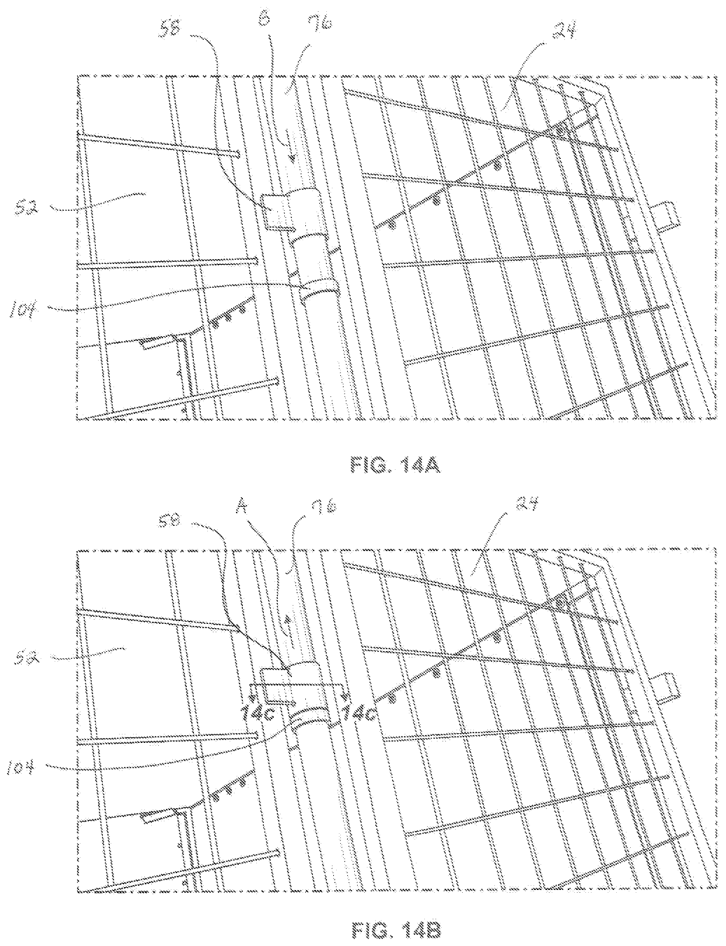

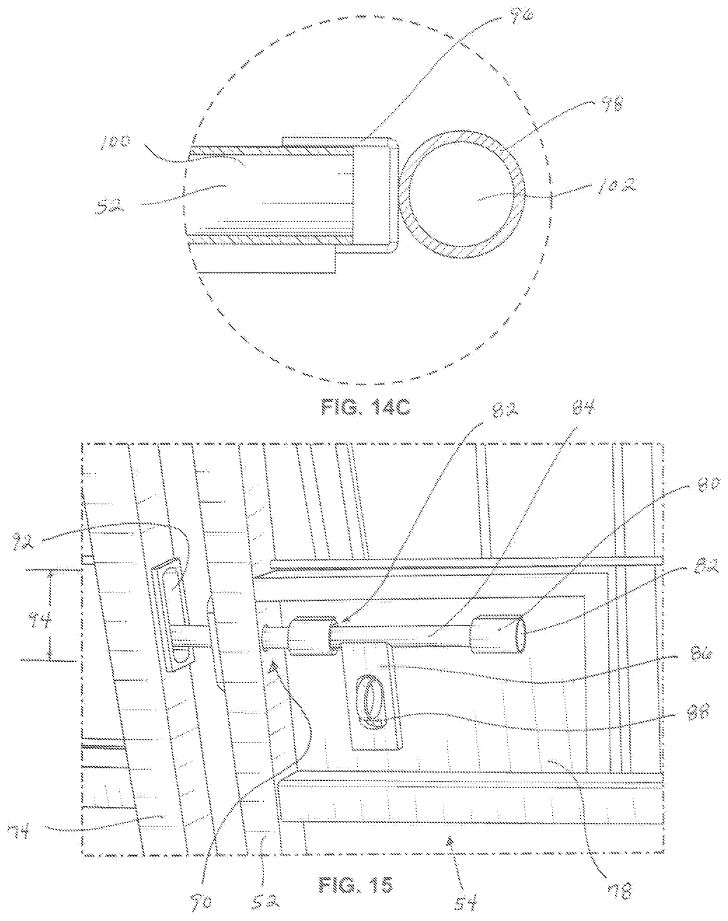

Turning to FIGS. 2 and 14A, 14B, and 14C, the first panel 24 or front panel 24 and the slide hinge 58 are more clearly illustrated. In the preferred embodiment, there are three (3) slide hinges 58, each positioned along the supporting vertical hinge bar 77 of the first panel 24 or front panel 24 and separated by a substantially equal length. Alternatively, more or less slide hinges 58 may be used and/or separated as desired provided that it fixedly secures the gate or door 52 to the supporting vertical hinge bar 77.

In the preferred embodiment, the slide hinge 58 provides a hinge plate 96 and a hinge tube 98. The hinge plate 96 is a U-shaped plate and fixedly secured to the frame bar 100 of the gate or door 52. Alternatively, the hinge plate 96 may be any shape and fixedly secured to the frame bar 100 of the gate or door 52 in any manner known to one skilled in the art. The hinge tube 98 is fixedly secured to the hinge plate 96 and provides a hinge tube hole 102 for attachment to the supporting vertical hinge bar 77 such that the supporting vertical hinge bar 77, while remaining attached to or retained within the hinge tube 98, is freely moveable within the hinge tube hole 102 of the hinge tube 98. In this manner, as illustrated in FIG. 14B, while the gate or door 52 remains attached to the supporting vertical hinge bar 77 of the first panel 24 or front panel 24, the slide hinge 58 permits the gate or door 52 to move upwardly in the direction of Arrow A thereby adjusting the height of the gate or door 52 in relation to the first panel 24 or front panel 24; or, as illustrated in FIG. 14A, while the gate or door 52 continues to remain attached to the supporting vertical hinge bar 77 of the first panel 24 or front panel 24, the slide hinge 58 permits the gate or door 52 to move downwardly in the direction of Arrow B thereby adjusting the height of the gate or door 52 in relation to the first panel 24 or front panel 24.

A stop 104 is also fixedly attached or secured to the supporting vertical bar 76 is provided to retain the slide hinge 58 in position.

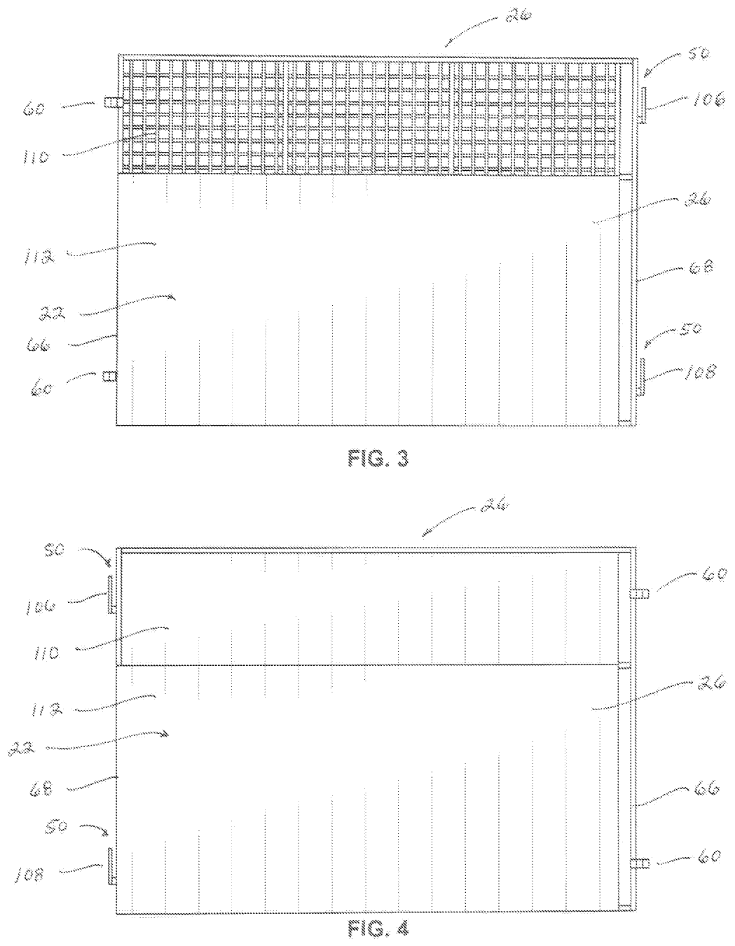

Turning to FIGS. 3 and 4, the second panel 26 (also referred to as side panel 26 or back panel 26) is more clearly illustrated. The second panel 26 is separated into two sections: a top section 110 and a bottom section 112. The top section 110 is preferably a mesh screen made of steel or, alternatively, a thin textile material providing many small holes (e.g., such as square as illustrated or in any other shape as desired). In this manner, such as for equestrian use, the horse being stabled or rider, trainer, or other person using the stable 20 can see through the second panel 26. Alternatively, the top section 110 may be covered with the canvas 22 and, preferably, the bottom section 112 is covered with the canvas 22. Thus, the option remains with the user as whether to keep the top section 110 covered or to remove the canvas 22 revealing the mesh screen. In this manner, this feature may be used as a divider, as desired, to open fully, open partially, or keep fully closed. it gives the user the further option to allow maximum versatility to include removing a single top canvas (e.g., one of the second panel 26 of stable 20, if formed into a square shape) to either allow for better air flow, or allow horses/riders to see each other if need be; or removing a single top to maximize ventilation without compromising privacy at times. Additionally, the mesh screen may be used to secure or hang accessories, if needed.

Second panel pins 106, 108 (also, referred to as side panel pins or back panel pins 106, 108) are fixedly secured or attached to only one (1) side of the second panel 26 (e.g., either the vertical bar 66 or the vertical bar 68). In the preferred embodiment, second panel pins 106 and 108 are fixedly secured or attached to the vertical bar 66 or 68, with second panel pin 106 situated adjacent to the top section 110 of the second panel 26 and the second panel pin 108 situated adjacent to the bottom section 112 of the second panel 26. Each of the second panel pins 106 and 108 are long and narrow and identical to one another and likewise provide substantially the same gap or separation 50 between each of the second panel pins 106 and 108 and the vertical bar 66 or 68 to receive the slide collar 60, of an adjacent panel, or free collar 62, as described in more detail below.

In the preferred embodiment, second panel pins 106 and 108 are substantially identical to the first panel or front panel pins 42, 44, 46, and 48; although, it is contemplated that they may be different provided that the are used in the manner to accomplish the invention described herein.

Slide collar 60 are fixedly secured or attached to only one (1) side of the second panel 26 (e.g., to either the vertical bar 66 or the vertical bar 68), whichever is the opposite side of the second panel 26 to where the second panel pins 106 and 108 are located. In this manner, the slide collar 60 and the second panel pins 106 and 108 are located on opposite sides of the second panel 26.

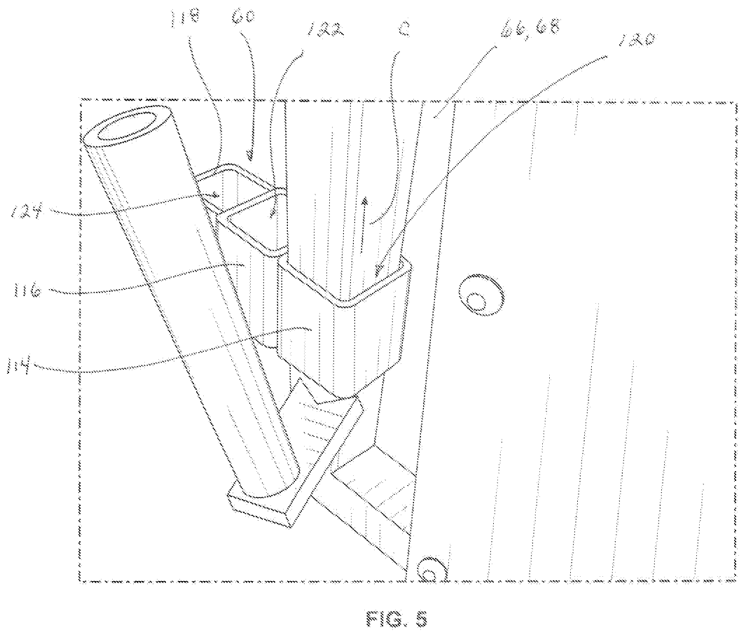

The slide collar 60 is more clearly illustrated in FIGS. 5 through 10. In the preferred embodiment, the slide collar 60 provides a main tube 114 having a main tube hole 120, a primary pocket 116 having a primary pocket hole 122, and a secondary pocket 118 having a secondary pocket hole 124. In the preferred embodiment, the primary pocket 116 and the secondary pocket 118 are situated adjacent or next to one another and extend outwardly from the vertical bar 66 or 68 of the second panel 26.

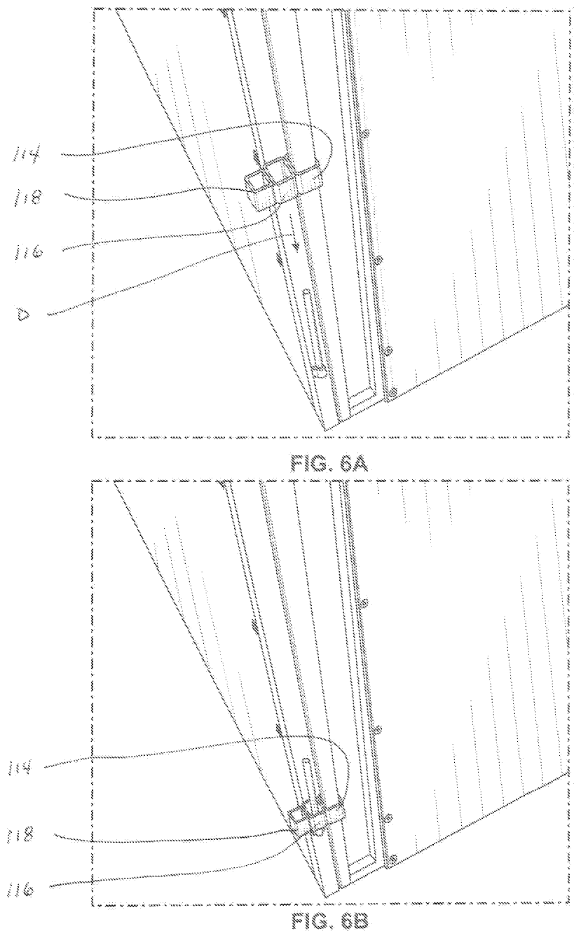

The main tube 114 is fixedly secured to the vertical bar 66 or 68 of the second panel 26 and provides the main tube hole 120 for attachment to the vertical bar 66 or 68 such that the slide collar 60, while remaining attached or retained to the vertical bar 66 or 68, is freely moveable in relation to the vertical bar 66 or 68 as the vertical bar 66 or 68 traverses through or within the main tube hole 120 as the slide collar 60 is moved. In this manner, while the slide collar 60 remains attached to the vertical bar 66 or 68 of the second panel 26, the slide collar 60 can freely move upwardly in the direction of Arrow C, as illustrated in FIG. 5, in relation to the vertical bar 66 or 68; or, as illustrated in FIGS. 6A, while the slide collar 60 continues to remain attached to the vertical bar 66 or 68 of the second panel 26, the slide collar 60 can freely move downwardly in the direction of Arrow D in relation to the vertical bar 66 or 68.

In this manner, when installing or assembling the stable 20, if you place the first panel 24 or front panel 24 perpendicular to the second panel 26 or side panel 26 and align the vertical bar 30 of the first panel 24 or front panel 24 next to the vertical bar 66 of the second panel 26 or side panel 26, the pins 42 and 44 will each be adjacent to a slide collar 60. Thus, when placing these panels next to one another, the attachment is accomplished using pins from one panel to the slide collars from the other panel (e.g., pin to collar combination).

In this manner, to secure the first panel 24 or front panel 24 to the second panel 26 or side panel 26, one of the slide collars 60 on the second panel 26 or side panel 26 will, while the slide collar 60 remains attached to the vertical bar 66, freely move along the vertical bar 66 filling in the gap or separation 50 until the pin 42 is fully received into the primary pocket hole 122 of the primary pocket 116 of this slide collar 60; and the other slide collar 60 on the second panel 26 or side panel 26 will, while the slide collar 60 remains attached to the vertical bar 66, freely move downwardly along the vertical bar 66 filling in the gap or separation 50 until the pin 44 is fully received into the primary pocket hole 122 of the primary pocket 116 of this other slide collar 60, as illustrated in FIG. 6B. As a result, the panels are attached using 2 pins from one panel to 2 slide collars from another panel. Alternatively, it is contemplated that the panels may be attached using more or less pins or slide collars combinations.

With the front panel 24 and side panel 26 secured together, and continuing with this same process, the next step to complete and form the stable 20 (e.g., such as into a square shape), the second panel 26 or back panel 26 is then placed perpendicular to the side panel 26 with the vertical bar 66 of the back panel 26 next to the vertical bar 68 of the side panel 26 such that the pins 106 and 108 in the side panel 26 will each be adjacent to a slide collar 60 in the back panel 26. Thus, when placing these panels next to one another, the attachment is accomplished using pins from one panel to the slide collars from the other panel (e.g., again pin to collar combination), as illustrated in FIG. 6B.

With the front panel 24 and side panel 26 secured perpendicularly together, and the side panel 26 secured perpendicularly to the back panel 26, and continuing with this same process, the next step to complete and form the stable 20 (e.g., such as into a square shape), another second panel 26 or side 26 is then placed perpendicular to the back panel 26 with the vertical bar 68 of the side panel 26 next to the vertical bar 68 of the back panel 26 such that the slide collar 60 in the side panel 26 will each be adjacent to the pins 46 and 48 in the front panel 24. Thus, when placing these panels next to one another, the attachment is accomplished using pins from one panel to the slide collars from the other panel (e.g., again pin to collar combination), again, as illustrated in FIG. 6B.

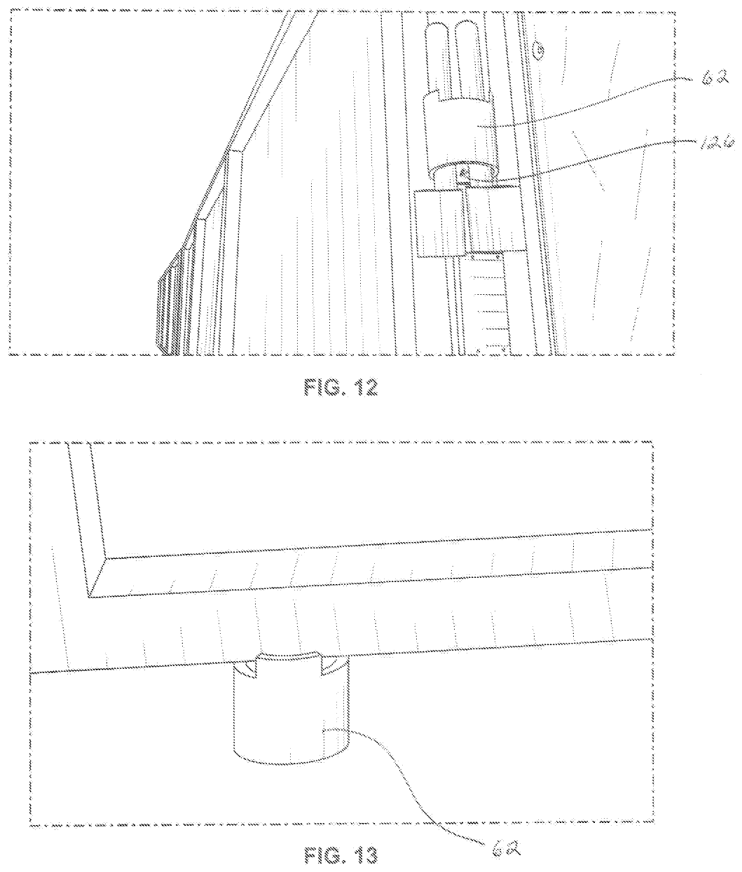

With the front panel 24 and side panel 26 secured perpendicularly together, the side panel 26 secured perpendicularly to the back panel 26, and side panel 26 secured perpendicularly to front panel 24, and continuing with this same process, the next step to complete and form the stable 20 (e.g., such as into a square shape), is to secure side panel 26 to the back panel 26. Since these panels are already in place, the vertical bar 68 of the another side panel 26 is next to the vertical bar 68 of the back panel 26 such that the pins 106 and 108 in the another side panel 26 are each adjacent to the pins 106 and 108 in the back panel 26. Thus, with these panels next to one another, the attachment is accomplished using pins from one panel to the pins from the other panel (e.g., pin to pin combination), and the free collar 62, in the example as illustrated in FIG. 12.

In this manner, to secure this another side panel 26 to the back panel 26 in the pin to pin combination, the free collar 62 providing a free collar hole 126 is placed over the adjacent pins from each of the panels with the adjacent pins being received into the free collar hole 126 and retained together by the free collar 62. Additionally, the free collar 62 may be used as a frame support on uneven ground surfaces when installing or assembling the stable 20, as illustrated in FIG. 13.

With the front panel 24 and side panel 26 secured perpendicularly together, the side panel 26 secured perpendicularly to the back panel 26, the back panel 26 secured perpendicularly to another side panel 26, and the another side panel 26 secured perpendicularly to the front panel 24, the installation and assembly of the stable 20 (e.g., such as into a square shape) is now complete.

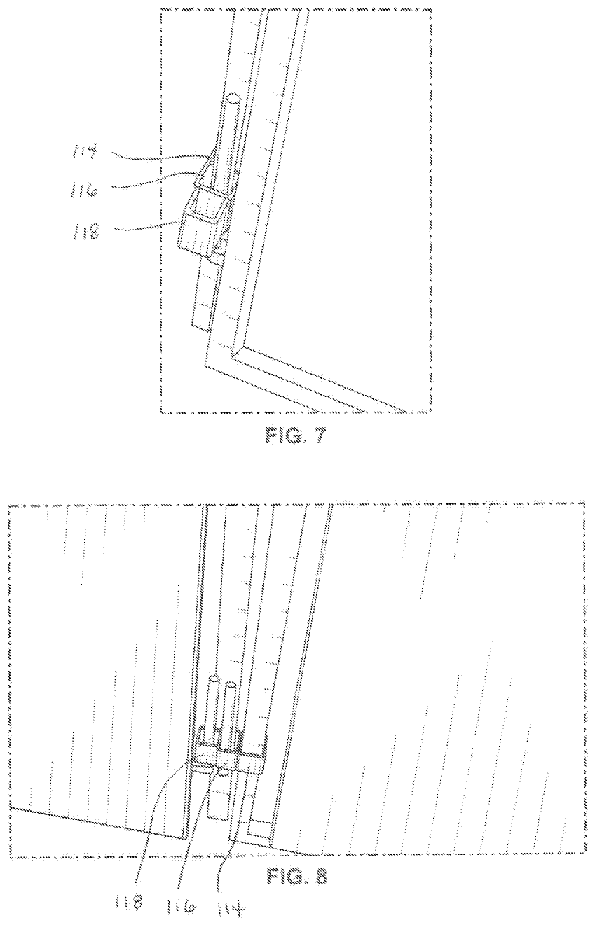

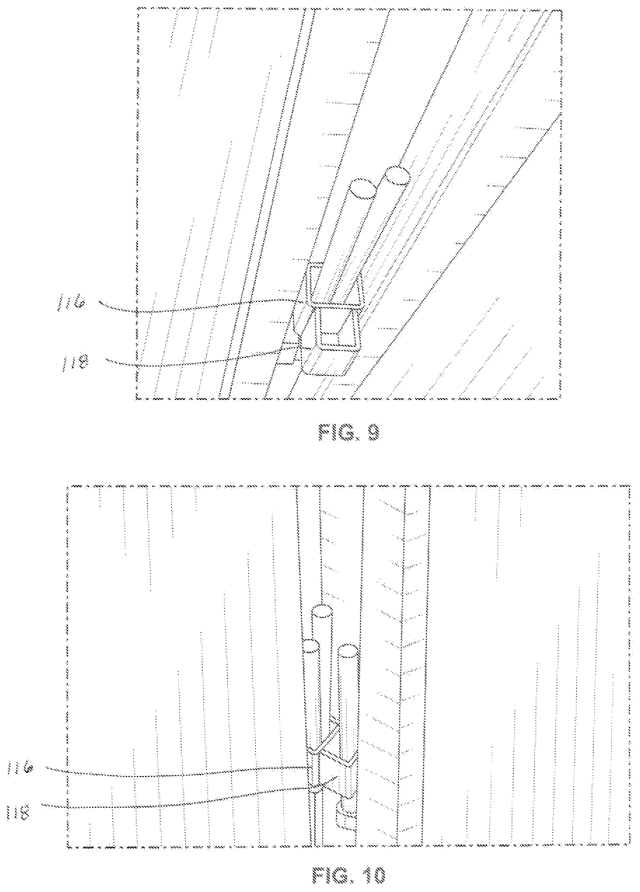

Should a second stable 20 be desired to be installed or assembled next to the stable 20 that was just assembled, the secondary pocket 118 of the slide collar 60 (and not yet used), as illustrated in FIGS. 6A, 6B, and 7, can then be used (in the same manner and process as previously described) to combine further first panels 24, second panels 26, side panels 26, or back panels 26 together in the pin to collar combination, as illustrated in FIG. 8; or multiple pin to pin combinations, as illustrated in FIGS. 9 and 10; and the free collar 62 can be used (in the same manner and process as previously described) to combine further first panels 24, second panels 26, side panels 26, or back panels 26 together in the pin to pin combinations, again, as illustrated in FIG. 12. Alternatively, the first panels 24, second panels 26, side panels 26, or back panels 26 can be combined together in any manner (or combination), as desired.

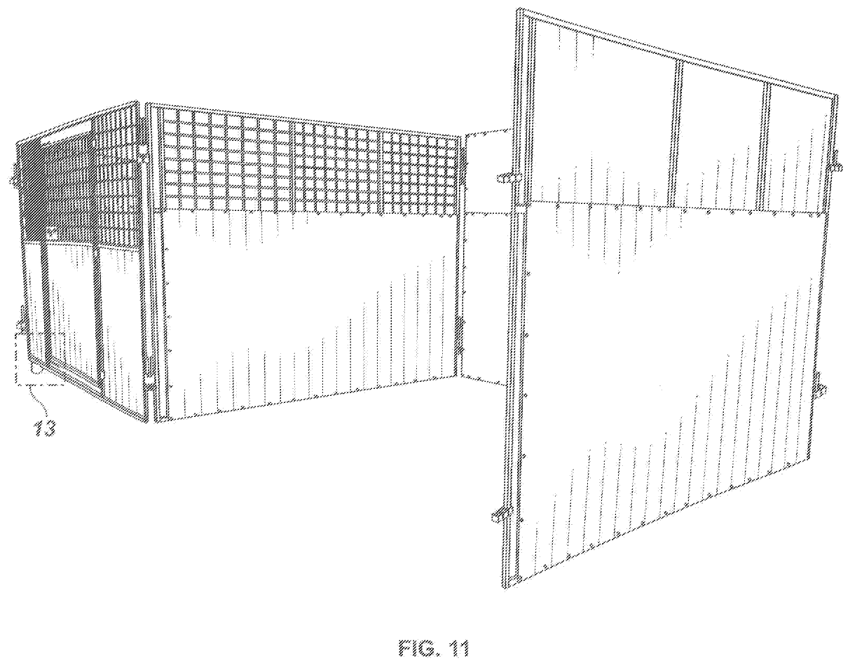

Thus, in Applicant's invention, however, many more panels can be attached to the current square stable 20 to form a many stables 20 next to one another in a single row, double row, or any combination(s) as desired, as illustrated in FIG. 11.

Based on the foregoing, Applicant's stable 20 provides many advantages including at least the following:
(a) uses only two (2) lightweight panel types with an inclusive coupling system that uses or only needs two (2) separate collars that can be configured in various ways on various terrain to create stables;
(b) sealed steel frame construction prevents moisture from entering the steel frame and prevents rust or rot forming internally;
(c) user friendly, safe, durable, very efficient, versatile, cost effective, and provides longevity with minimal maintenance, making it perfect for commercial or consumer use;
(d) the canvas with the bar spacing (which doesn't require any fillers in-between the canvas) creates a pocket of air that acts as a cushion, for example, when it is kicked by a horse and thereby alleviates injury to the horse and/or stall;
(e) the grate on the gate doesn't give, for example, a horse the chance to get their leg caught, whereas, the vertical bars on gates with other prior art solutions creates the chance for a horse to get their leg caught and injured; and
(f) maximize efficiency by simplifying the set up and tear down process.

Thus, there has been provided Applicant's portable stabling apparatus. While the invention has been described in conjunction with a specific embodiment, it is evident that many alternatives, modifications and variations will be apparent to those skilled in the art in light of the foregoing description. Accordingly, it is intended to embrace all such alternatives, modifications and variations as fall within the spirit and scope of the appended claims.

What is claimed is:

1. A portable stabling apparatus, comprising:
a first panel providing a first frame formed from opposed vertical bars;
a pin fixedly secured to each of the opposed vertical bars;
a second panel providing a second frame formed from opposed vertical bars;
a slide collar in slideable communication with one of the opposed vertical bars of the second panel;
a second pin fixedly secured to the other of the opposed vertical bars of the second panel;
a free collar;
wherein, to attach the first panel to the second panel, one of the opposed vertical bars of the first panel is placed next to one of the opposed vertical bars of the second panel and the slide collar traverses along the one of the opposed vertical bars of the second panel and is releaseably secured to the pin on the one of the opposed vertical bars of the first panel or one of the opposed vertical bars of the first panel is placed next to one of the opposed vertical bars of the second panel with the pin of the first panel situated adjacent to the second pin of one of the opposed vertical bars of the second panel with the free collar engaging both the first pin and the second pin.

2. The portable stabling apparatus of claim 1 wherein the pin is situated adjacent to an exterior of each of the opposed vertical bars.

3. The portable stabling apparatus of claim 2 wherein the pin is an elongated member aligned in the vertical orientation in relation to the ground and parallel to each of the opposed vertical bars.

4. The portable stabling apparatus of claim 3 wherein the second pin is substantially the same as the pin.

5. The portable stabling apparatus of claim 4 wherein the second pin is aligned in the vertical orientation in relation to the ground and parallel to the other of the opposed vertical bars of the second panel.

6. The portable stabling apparatus of claim 1 wherein the slide collar provides a main tube having a main tube hole, a primary pocket having a primary pocket hole, and a secondary pocket having a secondary pocket hole.

7. The portable stabling apparatus of claim 6 wherein the main tube is attached to the one of the opposed vertical bars of the second panel.

8. The portable stabling apparatus of claim 7 wherein with the one of the opposed vertical bars of the second panel is received into and through the main tube hole.

9. The portable stabling apparatus of claim 8 wherein the slide collar, while remaining attached to the one of the opposed vertical bars, is freely moveable in relation to the one of the opposed vertical bars as the one of the opposed vertical bars traverses through the main tube hole when the slide collar is moved.

10. The portable stabling apparatus of claim 9 wherein, to releaseably secure the slide collar on the opposed vertical bars of the second panel to the pin on the one of the opposed vertical bars of the first panel, the pin is received into the primary pocket hole of the primary pocket of the slide collar.

11. The portable stabling apparatus of claim 10 wherein the free collar provides a free collar hole.

12. The portable stabling apparatus of claim 11 wherein to releaseably secure the pin of one of the opposed vertical bars of the second panel to the second pin on one of the opposed vertical bars of the second panel, each of the pin and the second pin are received into the free collar hole of the free collar.

13. The portable stabling apparatus of claim 12 wherein the primary pocket and the secondary pocket are situated adjacent to one another and extend outwardly from the one of the opposed vertical bars of the second panel.

14. The portable stabling apparatus of claim 13 and further providing a back panel.

15. The portable stabling apparatus of claim 14 wherein the back panel is substantially identical to the second panel.

16. The portable stabling apparatus of claim 15 and further providing another second panel.

17. The portable stabling apparatus of claim 16 wherein the another second panel is substantially identical to the second panel.

18. The portable stabling apparatus of claim 17 wherein, to releaseably secure the back panel to the second panel, one of the opposed vertical bars of the back panel is placed next to the other of the opposed vertical bars of the second panel and the slide collar traverses along the one of the opposed vertical bars of the back panel and is releaseably secured to the pin on the other of the opposed vertical bars of the second panel.

19. The portable stabling apparatus of claim 18 wherein, to releasably secure the another second panel to the back panel, the other of the opposed vertical bars of the back panel is placed next to one of the opposed vertical bars of the another second panel and the slide collar traverses along the one of the opposed vertical bars of the first panel and is releaseably secured to the pin on the other of the opposed vertical bars of the front panel.

20. The portable stabling apparatus of claim 19 wherein, to releasably secure the another second panel to the second panel, the other of the opposed vertical bars of the another second panel is placed next to the other of the opposed vertical bars of the second panel with the pin of the another second panel situated adjacent to the pin on the other of the opposed vertical bars of the second panel with the free collar engaging both the another second pin and the pin.
